(19) United States
(12) Patent Application Publication
(10) Pub. No.: US 2019/0155568 A1
(43) Pub. Date: May 23, 2019

(54) LIVE PRESENTATION DELIVERY AID SYSTEM AND METHOD

(71) Applicant: Serious Biz, LLC, Bellevue, WA (US)

(72) Inventor: Nickolas Sears, Seattle, WA (US)

(21) Appl. No.: 15/818,613

(22) Filed: Nov. 20, 2017

(51) Int. Cl. G06F 3/16; H04R 1/10; G06F 3/0481

(52) U.S. Cl. CPC G06F 3/167; G06F 3/0481; G06F 3/165; H04R 1/1016

(57) ABSTRACT

For the foregoing reasons, there is a need for a need for a presentation aid that (a) physically frees the presenter to deliver a presentation while moving, gesturing, and maintaining eye-contact during the presentation, (b) reduces audience distraction by allowing removal of an audience display that presents any significant portion of the presentation content, (c) provides presenter control over prompt content and timing, and (d) allows the presenter to deviate and adapt the presentation to the audience and situational variables.

### FIELD OF THE DISCLOSURE

This disclosure relates generally to the field of live presentation aids.

### BACKGROUND

Many live presentations are delivered using some type of presenter support or presentation aid application, such as PowerPoint or Keynote, to guide the presenter and to deliver key information to the audience through a series of slides. Presentation aids often allow the presenter to move forward or backward through a presentation, one slide at a time, using a keyboard, touchscreen, or remote control. Presentation aids are enormously helpful to presenters by reducing the mental burden of recalling the overall structure of a presentation and providing key details when needed. Such aid significantly improves presenter confidence and overall presentation content and effectiveness.

Many presentation aid applications include a Presentation Mode that provides a visual display output to the audience, while also providing a presenter-specific visual output that includes additional or separate information. In Presentation Mode, the slideshow may be played simultaneously on the presenter's small screen and the audience's large screen, with the small screen including additional aids such as timer, talking notes, and a preview of upcoming slides.

While the Presentation Mode system is very successful at supporting the presenter during a presentation, such systems tend to diminish audience engagement, information absorption, and overall presentation effectiveness for several reasons. Presentation Mode requires a presenter to be within a suitable viewing position of the presenter screen, which significantly limits the movement of the presenter. Furthermore, the presenter screen, when positioned practically, in consideration of the audience and presenter positions, is generally placed between the presenter and the audience. This positioning creates a physical separation between presenter and audience, restricts movement, and reduces hand gesturing opportunity and visibility. Eye contact is also significantly interrupted by such a system, as the presenter must frequently break eye contact and attention to the audience in order to view and interact with the presenter screen. For each of these reasons, the presenter performance and presentation efficacy is negatively affected.

Teleprompter systems provide an alternative presentation aid that reduces physical and visual barriers between presenter and audience, but such systems significantly restrict a presenter's ability to move about or traverse a stage. Additionally, teleprompters are best adapted to monologue-style presentations in which presenters proceed linearly and without significant deviation from a predetermined script. This type of system is poorly suited for many live presentations, as presenters are often required to adapt their presentation delivery depending upon situational variables.

Audience behavior is also negatively affected by typical implementations of visual presentation aids. In many cases, presentation aids present condensed or bulletized information on the audience screen that the presenter will then discuss and elaborate. Audience members will frequently quickly read through the presentation bullets in order to glean the gist of the presentation, and consequently are enabled to ignore the live presenter. The effect is that the audience members are deprived of elaboration and narrative flow. Presenters are faced with the conundrum of competing with their own presentation slides for audience attention. Although a presenter could theoretically eliminate the audience display screen, the presenter would still be tethered to some degree to the presenter screen and thereby limited in their ability to actively engage with the audience.

In very well-executed audience displays, slides or visual aids are highly limited and are used for specific compelling effect or to highlight significant points, but such displays cannot stand alone without the concurrent presentation delivery. Used in this manner, audience displays can enhance a presentation's effect, but they do not tend to guide the presenter in any meaningful way.

Existing non-visual presentation aids are also quite limited. Actors and live television presenters such as news anchors can be aided by off-stage prompting given by a crew-member. This may happen aloud or by delivery through an earpiece. This solution is impractical in most situations as it requires additional personnel, and places much of direction of the presentation in the hands of someone other than the presenter.

An alternative non-visual presentation aid solution is to provide a prerecorded version of the script through an earpiece to the presenter, such that the presentation is delivered continuously to the presenter, and the presenter must only repeat the presentation as it is played back. Such systems have a number of disadvantages including challenging execution, typically requiring significant training and practice to allow the presenter to be able to simultaneously listen to and repeat the presentation. This method also prohibits deviation from the prerecorded version, which prevents the presenter from adapting presentation to the situation and audience.

Reference to, and discussion of, the foregoing background is not presented as prior art and is respectfully submitted that none of the above-indicated technologies disclose, teach, suggest, show, or otherwise render obvious, either singly or when considered in combination, the invention described and claimed herein.

For the foregoing reasons, there is a need for a need for a presentation aid that (a) physically frees the presenter to deliver a presentation while moving, gesturing, and maintaining eye-contact during the presentation, (b) reduces audience distraction by allowing removal of an audience display that presents any significant portion of the presentation content, (c) provides presenter control over prompt content and timing, and (d) allows the presenter to deviate and adapt the presentation to the audience and situational variables.

### SUMMARY

An object of the present invention is to provide a system and method that provides prompting to a presenter in a manner that guides the presenter through a presentation's content in a manner that does not otherwise detract from the presentation quality.

It is a further object of the invention to aid a presenter in developing quality and accessible presentations by providing templates or schema by which presentation content may be produced and organized.

These and other objects are carried out by a system in which a user may prepare a presentation that incorporates separate audio and visual output for the presenter and the audience. The system will guide a user to record a series of audio prompts for the presentation such that the audio prompts are optimized to aid presentation delivery. The content of individual recordings may be guided by templates that are known to effectively deliver presentation content. Each audio prompt may have associated presenter visual content, as well as associated audience visual or audio content.

A user performing a presentation may access the recorded audio prompts by requesting playback of an audio prompt through a user interface. Presentation audio prompts and associated content is delivered upon demand with user control of content playback timing and order. Audio prompts are played back through a dedicated presenter audio component, such as an earpiece. A presenter may also reference visual aid material associated with a given prompt. Presenter visual aids may be displayed on a screen dedicated to and visible only to the presenter. Separate audience audio and visual output that is associated with a given prompt may also be played or displayed through an audience A/V system. The inventor has discovered that during performance of a presentation, audio prompts should be sufficiently short in duration to avoid the audience perceiving unnatural pauses in the presenter speech pattern. In the preferred embodiment, the audio prompts are time-limited to two (2.0) seconds in order to avoid creating said unnatural pauses.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 shows a schematic diagram of a presentation delivery aid system.

FIG. 2 shows a presentation flow diagram.

FIG. 3 shows an embodiment of a prompt template.

FIG. 4. shows a flow diagram of generation and playback of a presentation outline

FIG. 5 shows a diagram of the system hardware.

### DEFINITIONS

Earpiece: An audio output speaker adapted to be placed on, in, or proximal to the ear of a single listener and intelligibly audible only to that listener.

### DETAILED DESCRIPTION

The disclosure presented herein relates to an interactive prompting system and method. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

While preferred and alternate embodiments have been illustrated and described, as noted above, many changes can be made without departing from the spirit and scope of the nesting deterrence device. Accordingly, the scope of the live presentation delivery aid system and method is not limited by the disclosure of these preferred and alternate embodiments. Instead, the scope of the live presentation delivery aid system and method should be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 116. In particular, the use of “step of” in the claims herein is not intended to invoke the provisions of U.S.C. § 112 ¶ 6.

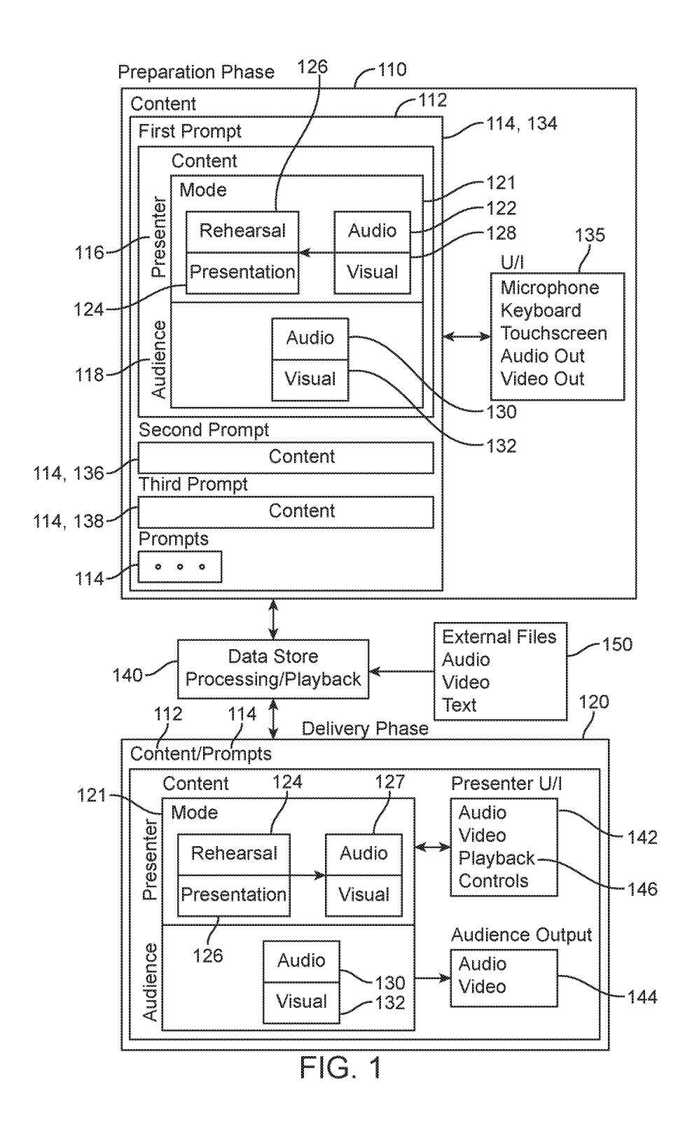

FIG. 1 is a schematic diagram of a presentation delivery aid system with a preparation phase 110 and a delivery phase 120 in accordance with embodiments of the inventive arrangements disclosed herein. Stages 110 and 120 are for illustrative purposes only, and are not meant to be interpreted as an absolute implementation or embodiment of the present disclosure.

In stage 110, a user prepares content for a presentation 100. The user will record presentation content 112. Presentation content 112 is comprised of a plurality of prompts 114. Each of the plurality of prompts will include presenter content 116 and may include audience content 118. In the preferred embodiment, the system provides presenter aid through audio prompts 122 that are adapted not to interfere with presentation delivery. In the preferred embodiment, audio prompts 122 are limited by time and/or length in order to avoid interference with presentation delivery. Therefore, a user may prepare presentation-version audio prompts 124 that are time and/or length limited. Users may also benefit from longer rehearsal-version audio prompts 126 that provide more content for rehearsal purposes. Each prompt may incorporate separate audience content 118. Prompts may include presenter visual content 128 such as additional notes or cues, audience audio content 130 such as music or other audio recordings, and audience visual content 132 such as text, images, video, or other visual content.

A user would record a first prompt 134 by inputting content through a user interface 135. The user interface may include a microphone, keyboard, touchscreen, monitor or display, or audio output. Users may import external data files 150 such as text, audio, or video files as content 112. Imported external files may be used to generate any portion of any prompt content 112. The user may then continue to record additional content 112, such as a second prompt 136, a third prompt 138, and so forth. Content 112 is stored in a data store 140.

In stage 120, the presentation content is delivered. During the delivery stage 120, user interface is divided such that there is a presenter U/I 142 and an audience output 144. The presenter U/I 142 includes playback controls 146 to allow the presenter to request playback of the next, previous, or other prompt. The presenter U/I will also include dedicated presenter audio output 127. The presenter audio output 127 is adapted to provide audio prompts 122 to the presenter such that the output 127 is not audible by the audience. Presenter-only audio output 122 may be accomplished by a dedicated presenter earpiece, headphones, or other specialized speaker arrangement. The audience output may include recorded audio 130 and/or visual 132 content.

During the delivery stage 120, a user may choose a mode 121 to deliver either rehearsal content 124 or presentation content 126. In an embodiment, as the user performs the presentation in the delivery stage 120, the user can request a first prompt 134 that contains cues for the information that the user will discuss within a portion of the presentation related to the first prompt 134. Upon request, the prompt is played back to the user, preferably through an earpiece such that only the user perceives the audio prompt. The user may then discuss the content related to the first prompt 134. The user may then request the second prompt 136 in the series and discuss the content of the second prompt 136. The user may continue in this fashion, calling prompts and discussing the related information as the user progresses through the presentation 100. The prompts would therefore guide the user in delivering the presentation completely and in the correct order. The user may also have the option of requesting replay of a given prompt 114 once or multiple times if desired through the playback controls 146, progressing sequentially, skipping ahead, or skipping backward through the prompts as desired, in order to adapt the presentation to the given situation and audience if necessary.

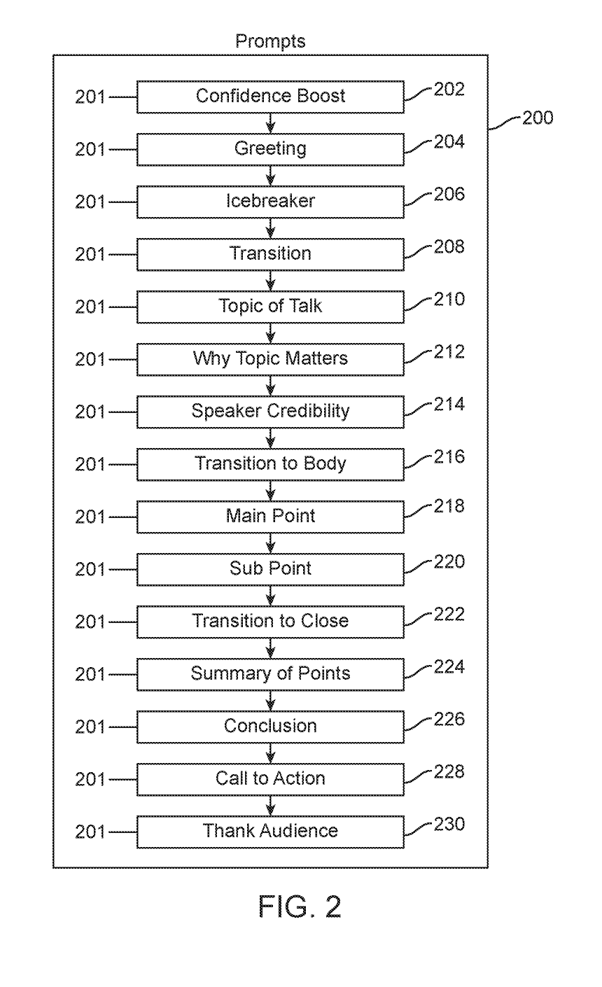

FIG. 2 shows a presentation flow diagram. A user would be guided to deliver content as prompts in a sequence that has been demonstrated to be successful at achieving high audience engagement and information retention. In an embodiment, the presentation 200 sequence of prompt topics 201 would include a confidence boost 202, greeting 204, icebreaker 206, transition 208, topic 210, significance 212, credibility 214, transition to body 216, main point 218, sub points 220, transition to close 222, summary 224, conclusion 226, call to action 228, and thanks 230. Alternative embodiments could include different or various sequences, each adapted to guide users in generating successful outlines for different types of presentations.

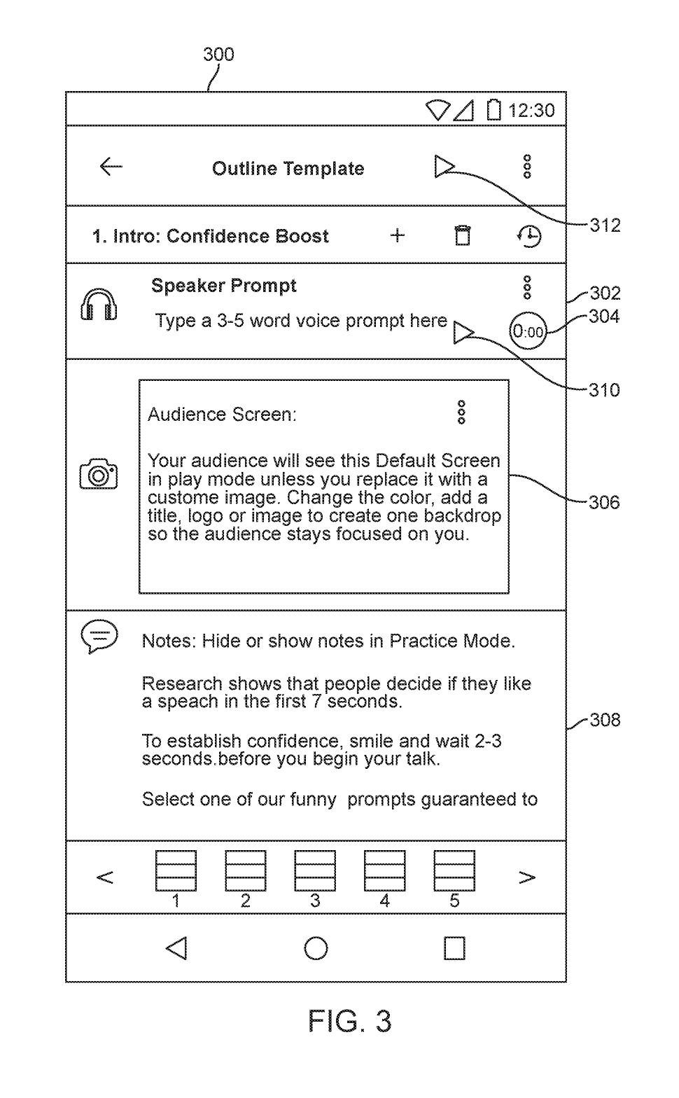

FIG. 3 shows an embodiment of a prompt template 300. In an embodiment, the system will provide a template 300 that a user would use to generate a prompt. The template 300 would guide a user to adapt the portions presentation content to allow for effective rehearsal and delivery. A user would be required to record an audio prompt 302. The audio prompt 302 would correspond to a prompt topic 201. Prompt topics 201 may be supplied or may be user defined. The inventor has discovered that during performance of a presentation, audio prompts 302 should be sufficiently short in duration to avoid the audience perceiving unnatural pauses in the presenter speech pattern. In the preferred embodiment, the audio prompts are time-limited to two (2.0) seconds in order to avoid creating said unnatural pauses. In other embodiments, time limitation of the audio prompt duration are customizable to be longer or shorter, thereby accommodating individual user-style or presentation requirements. In an embodiment, longer duration prompts may be allowed during presentation rehearsal. Individual prompts may be edited or replaced, thereby allowing a user to optimize the prompts to be as unobtrusive as possible while still providing adequate cueing information. In an embodiment, the system may impose prompt length limits based on word, syllable, or character counts. In an embodiment, the audio prompt would include a timer 304 that indicates prompt duration. Play button 310 give users the ability to play back individual prompts for editing or other purposes.

In an embodiment, the prompt would include a field for an audience display 306. In the preferred embodiment the audience display shows a default screen. The prompt further includes a presenter note field 308. This note field may be used to guide rehearsal or used within the presentation delivery. Presenters may request audio or text-to-speech delivery of the note field in order to aid live presentation. Alternatively, the presentation field may be hidden or omitted during delivery.

In an embodiment, the system may assist users in prompt generation by providing suggested prompts or other content. The system may provide a list of prompts from which a user may choose for certain prompt types, such as the greeting or introduction.

In an embodiment, a user may begin presentation playback by pressing a play button 312. In alternative embodiments, a user may initiate playback through dedicated hardware buttons or button combinations.

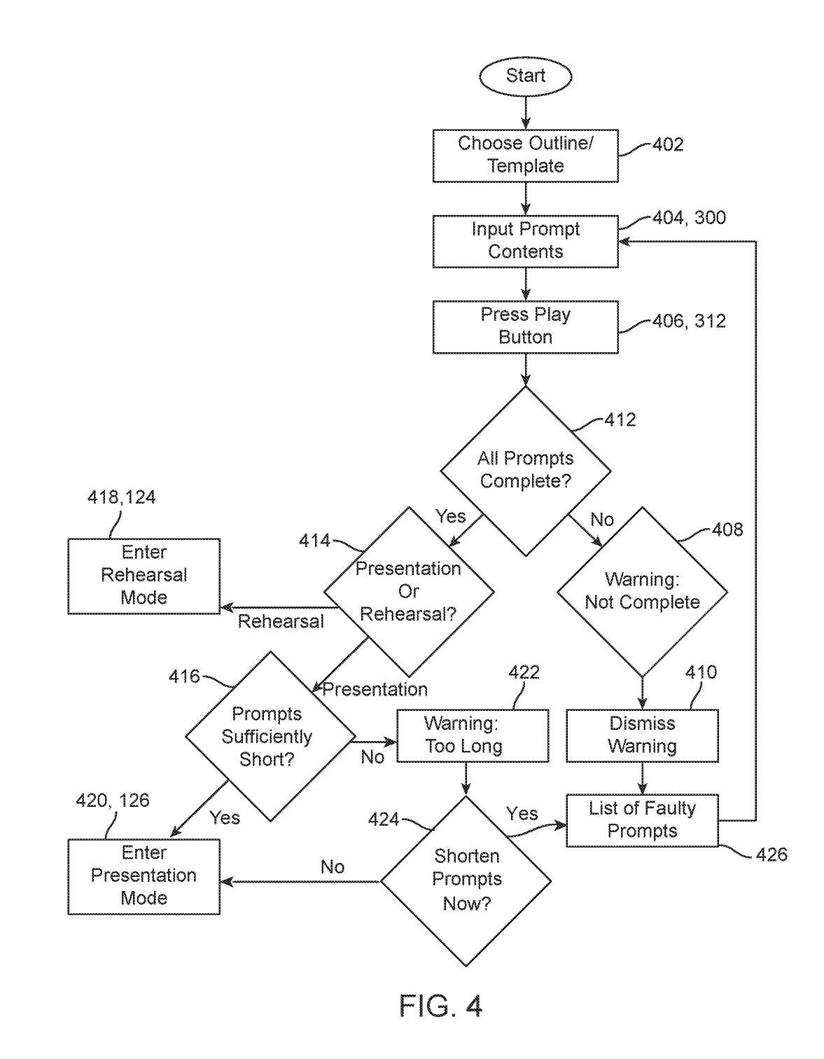

FIG. 4 shows a process flow diagram for a preferred method of generation and playback of a presentation outline. A user would begin by choosing a blank, partially blank, or completed template 402. The user would then input content to each prompt template 404. A user could request playback of the presentation by pressing the play button 406. If any prompt template remains incomplete 412, a faulty prompt warning 408 would appear. After dismissing 410 the warning 408, the user would be presented with a list of faulty prompts 426, and the user would be required to add or correct prompt contents. If all prompt content exists 412, a user would be prompted to select a mode 414: Rehearsal Mode 418 or Presentation Mode 420. If a user selects Rehearsal Mode 418, the system would enter that mode and rehearsal could commence. If the user selects Presentation mode, and all prompts are sufficiently short 416, the system would enter Presentation mode 420. If the user selects Presentation Mode 420, and any prompt is insufficiently short, a long prompt warning 422 would appear, and the user would be presented with the option 424 to either shorten prompts immediately or continue into presentation mode 420. If the user opts to shorten prompts, the system will return a list of faulty prompts 426 and then return to prompt content input 404.

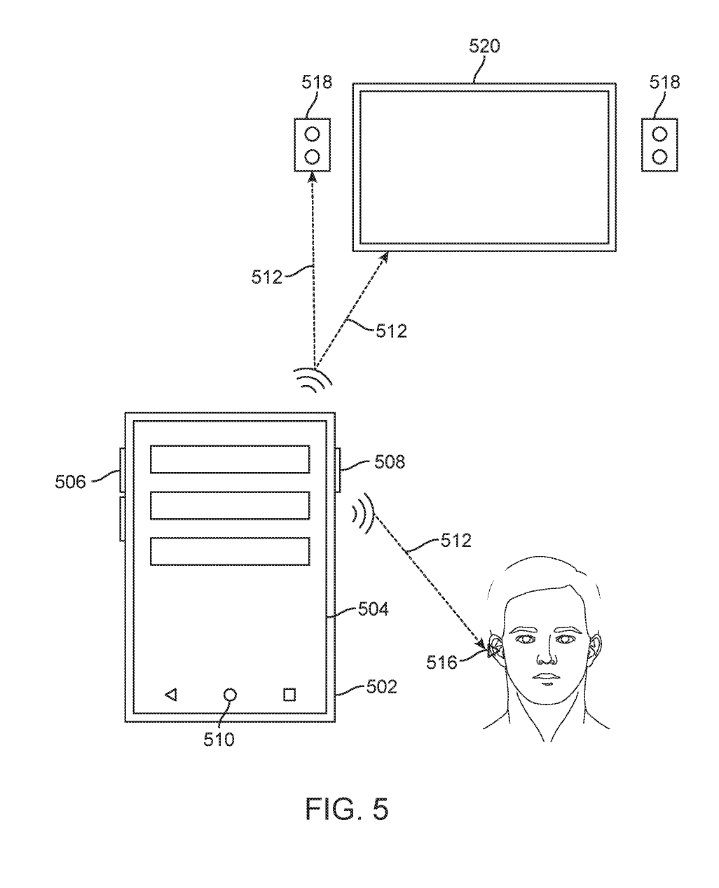

FIG. 5 shows a diagram of the system hardware. In an embodiment, prompt files are stored locally on a storage and playback system 502 that is carried with the presenter, such as a smartphone. Playback requests are entered by a user through a user interface. In an embodiment, the user interface is a physical or virtual interface that is integral to the storage and playback system. In the preferred embodiment, the storage and playback system 502 is a smartphone. In alternative embodiments, the storage and playback device is a desktop or laptop computer. In an embodiment, the storage and playback device 502 runs an application providing user interface through the touch sensitive GUI 504 and the integrated hardware interface buttons, such as the volume buttons 506, power buttons 508, or home button 510. In an embodiment, presentation and prompt files are stored locally on the storage and playback system 502. In alternative embodiments, prompt files may be stored remotely and accessed via a data connection. In an embodiment, the user interface may be situated on a dedicated remote that allows the user to remotely request playback of a prompt file. Dedicated presentation remotes for use with visual presentation aids, such as PowerPoint, are well known in the art, and in an embodiment, a similar dedicated remote could be used to request audio prompts. A dedicated remote may be proprietary to the system or it may be generic and adaptable for use with the system.

In the preferred embodiment, the storage and playback device 502 transmits presentation audio and visual outputs wirelessly 512 to output devices. In an embodiment, audio playback to a system user is through wireless headphones or an earpiece 516. In an embodiment, playback is through a wired earpiece or headphones that physically connect to a playback device via a wired connection. In the preferred embodiment, playback is through a physically discrete wireless earpiece 516 that is not readily visible to an audience.

In an embodiment, audio prompts are recorded on a channel of a multiple channel audio recording. In this embodiment, prompt channel playback may be simultaneous with playback of other channel audio playback. Certain of said multiple channels may be played back audibly for the audience through an audience speaker system 518, while the presenter would receive the separate presenter prompts. In an embodiment, audience visuals are wirelessly transmitted to an audience display 520.

In an embodiment, a text to speech system may be used to generate audio prompts from text. A text string could be converted to a recorded audio prompt or prompts. A system user may input text in a prompt field to generate an audio prompt.

In an embodiment, a user may modify playback speed of an audio prompt. In alternative embodiments, prompt playback speed may be automatically adjusted by the playback program or device.

1. A computer-based presentation support system for providing on-demand presenter support comprising:
a device capable of storing a series of presentation audio prompts and serving said series of audio prompts to a presenter audio output speaker as a presenter audio output,
said presenter audio output being audible only to a presenter,
a user interface having a plurality of physical buttons,
said physical buttons being operable by the presenter to demand playback of any immediately previous, present, or immediately subsequent audio prompt within the series of presentation audio prompts,
such that any immediately previous, present, or immediately subsequent audio prompt contained within the series of presentation audio prompts is playable upon presenter demand and audible only to the presenter, and
each of said audio prompts contained within the series of presentation audio prompts has a maximum duration that is less than or equal to a natural pause in speech of said presenter,
wherein said natural pause in speech of said presenter is 3.0 seconds.

2. (canceled)

3. (canceled)

4. (canceled)

5. The system of claim 1, wherein the maximum duration is between 0.5 and 3.0 seconds.

6. (canceled)

7. (canceled)

8. A computer-based presentation aid system for providing on-demand presenter support comprising:
a processor program configured to store a series of presentation audio prompts and configured to serve said series of presentation audio prompts,
such that said presenter audio output being audible only to a presenter,
a user interface operable by the presenter that allows the presenter to request playback of any immediately previous, present, or immediately subsequent audio prompt within the series of presentation audio prompts,
such that any immediately previous, present, or immediately subsequent audio prompt contained within the series of presentation audio prompts is playable upon presenter demand and audible only to the presenter,
wherein the audio prompts contained within the series of presentation audio prompts have a maximum duration that is less than or equal to a presenter natural pause in speech of 3.0 seconds.

9. The presentation aid system of claim 8, wherein the presenter audio output speaker is an earpiece.

10. (canceled)

11. (canceled)

12. (canceled)

13. The system of claim 8, wherein the maximum duration is 2.5 seconds.

14. The system of claim 8, wherein the maximum duration is 2.0 seconds.

15. A presentation delivery method comprising:
A user recording a series of audio prompts on a computer readable medium,
wherein each of said audio prompts is limited to a maximum duration of 3.0 seconds,
wherein each of said audio prompts provides information corresponding to a portion of a live presentation,
a presenter requests an output of said audio prompts via a user-interface,
wherein said output is through a presenter audio output speaker in response to said presenter request,
wherein said output being audible only by the presenter,
said output requested by said presenter may be any immediately previous, present, or immediately subsequent audio prompt, and
the presenter discusses the portion of the live presentation that corresponds to the audio prompt.

16. The presentation delivery method of claim 15, wherein the presenter audio output speaker is an earpiece.

17. The presentation delivery method of claim 15, wherein the maximum duration is 2.5 seconds.

18. The presentation delivery method of claim 15, wherein the maximum duration is 2.0 seconds.
